(19) United States
(12) Patent Application Publication
(10) Pub. No.: US 2026/0003653 A1
(43) Pub. Date: Jan. 1, 2026

(54) Creating User Interface Navigations with Natural Language Processing

(71) Applicant: ServiceNow, Inc., Santa Clara, CA (US)

(72) Inventors: Rakesh Mula, Santa Clara, CA (US); Maria Svoisky Goldberg, Santa Clara, CA (US)

(21) Appl. No.: 18/760,952

(22) Filed: Jul. 1, 2024

(51) Int. Cl. G06F 9/451; G06F 3/0481

(52) U.S. Cl. CPC G06F 9/453; G06F 3/0481; G06T 2200/24

(57) ABSTRACT

Various implementations disclosed herein include techniques for generation of guided content of user interfaces based on requirements for the guided content. An example implementation may involve receiving a set of requirements associated with guided content for a user interface; generating, via a trained natural language model, a representation of the guided content based on the set of requirements; and providing the representation of the guided content to a client device.

### BACKGROUND

Guided tours are user interface features used to introduce new users to a software platform (e.g., an application or website). These tours help users understand the layout, features, and functionalities of the software platform through a series of interactive steps. For example, a guided tour may lead a user through different parts of the user interface, highlighting key features and functionalities of each part. Unfortunately, guided tours take a significant amount of effort and planning to produce, as the user interface needs to be mapped into discrete components and helpful text and/or images for each component needs to be developed. Further, modern computing platforms are changing and adding new user interface features at a rate that limits the extent to which currently-developed guided tours can be effective.

### SUMMARY

Various implementations disclosed herein include techniques for generation of guided tours of user interfaces based on requirements for the guided tours. The guided tour may include various forms of textual, graphical, and/or auditory guided content. The requirements may take the form of one or more of a functional requirements document, a user stories document, and/or source code that implements the guided tour. A trained natural language processing model may be used to automatically generate further source code and/or metadata that can be used to implement the guided tour in conjunction with a user interface framework. Advantageously, doing so allows accurate and effective guided tours to be rapidly developed and deployed in production environments for more applications. The natural language processing model can be updated with feedback based on the tested and/or real-world efficacy of the guided tours that it produces. As a consequence, computing resources are conserved since users are able to navigate through user interfaces more effectively with less cycling through user interface pages and less going down fewer false paths.

Accordingly, a first example embodiment may involve receiving a set of requirements associated with guided content for a user interface; generating, via a trained natural language model, a representation of the guided content based on the set of requirements; and providing the representation of the guided content to a client device.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIGS. 6A, 6B, 6C, and 6D depict a user interface, in accordance with example embodiments.

FIG. 7 depicts a functional requirements document describing a guided tour for a user interface, in accordance with example embodiments.

FIG. 8 depicts a user stories document describing a guided tour for a user interface, in accordance with example embodiments.

FIGS. 9A and 9B depict source code of a guided tour for a user interface, in accordance with example embodiments.

FIG. 10 depicts user interface metadata of a guided tour for a user interface, in accordance with example embodiments.

FIGS. 11A and 11B respectively depict workflows for generating user interface source code and metadata, in accordance with example embodiments.

FIG. 12 depicts retraining and/or fine tuning of a natural language processing model, in accordance with example embodiments.

FIG. 13 depicts logging and analyzing user navigation through guided tours, in accordance with example embodiments.

FIG. 14 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is wastage of computing resources (e.g., processing, memory, and/or network capacity) due to users’ inefficient interactions with user interfaces. In practice, this is problematic because the users may load more user interface components and pages as they navigate cyclically and/or go down dead-end paths of the user interface that do not lead them to the desired content. Since each user interaction with a user interface requires at least processor utilization, and in many cases increased memory and network utilization, poorly-designed user interfaces result in less performative computing systems.

In other techniques, guided tours of user interfaces were included with these user interfaces. However, these techniques do not scale as the number of user interfaces on various computing platforms grows rapidly over time. Moreover, other approaches rely on subjective decisions and experiences of individual designers and developers of the user interfaces, which leads to wildly varying outcomes from instance to instance. Thus, other techniques did little to address user interface efficacy and the wastage of computing resources due to users being unable to efficiently interact with user interfaces.

The embodiments herein overcome these limitations by using a natural language processing model to generate guided tours for user interfaces based on textual or other requirements thereof. In this manner, guided tour implementation can be accomplished in a more, rapid, accurate, and robust fashion. This results in several advantages. First, users that engage with guided tours are able to navigate the underlying user interfaces more efficiently. Second, doing so results in less wastage of computing resources, as the users are less likely to wander about the user interfaces while seeking particular information or capabilities. Third, the natural language model can be improved by incorporating user interface efficacy information from logs of user activities.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise’s ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise’s operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise’s custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise’s network and used to manage such a network. The following embodiments describe architectural and functional aspects of example aPaaS systems, as well as the features and advantages thereof.

### III. Example Computing Devices and Cloud-Based Computing Environments

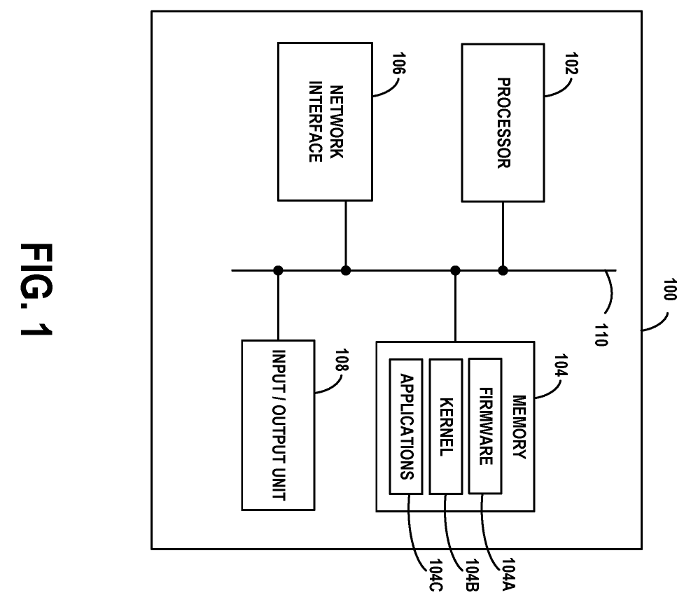

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input / output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input / output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input / output unit 108 may facilitate user and peripheral device interaction with computing device 100. Input / output unit 108 may include one or more types of input devices, such as a keyboard, a mouse, a touch screen, and so on. Similarly, input / output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

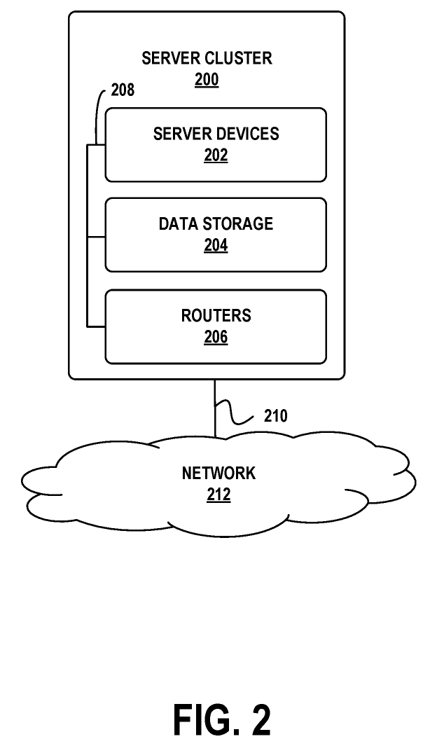

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

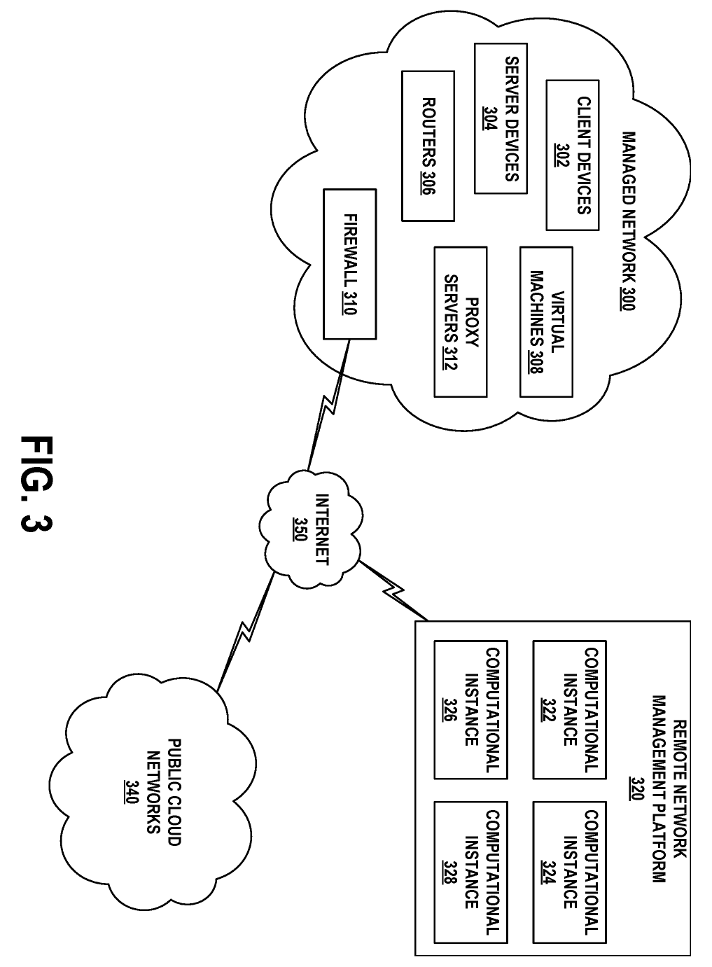

FIG. 3 depicts a remote network management architecture, in accordance with example embodiments. This architecture includes three main components – managed network 300, remote network management platform 320, and public cloud networks 340 – all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers’ data are separate from one another, the separation is enforced by the software that operates the single database. As a consequence, a security breach in this system may affect all customers’ data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer’s instance experiences an outage due to errors or an upgrade, other computational instances are not impacted. Maintenance down time is limited because the database only contains one customer’s data. Further, the simpler design of the multi-instance architecture allows redundant copies of each customer database and instance to be deployed in a geographically diverse fashion. This facilitates high availability, where the live version of the customer’s instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

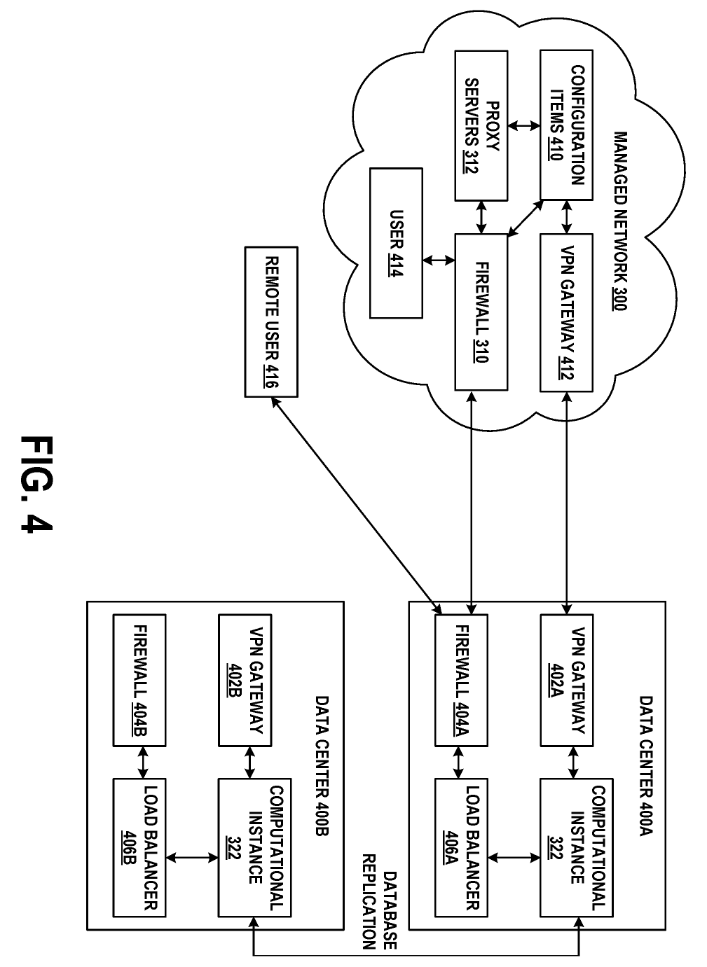

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0 – 10.255.255.255 or 192.168.0.0 – 192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

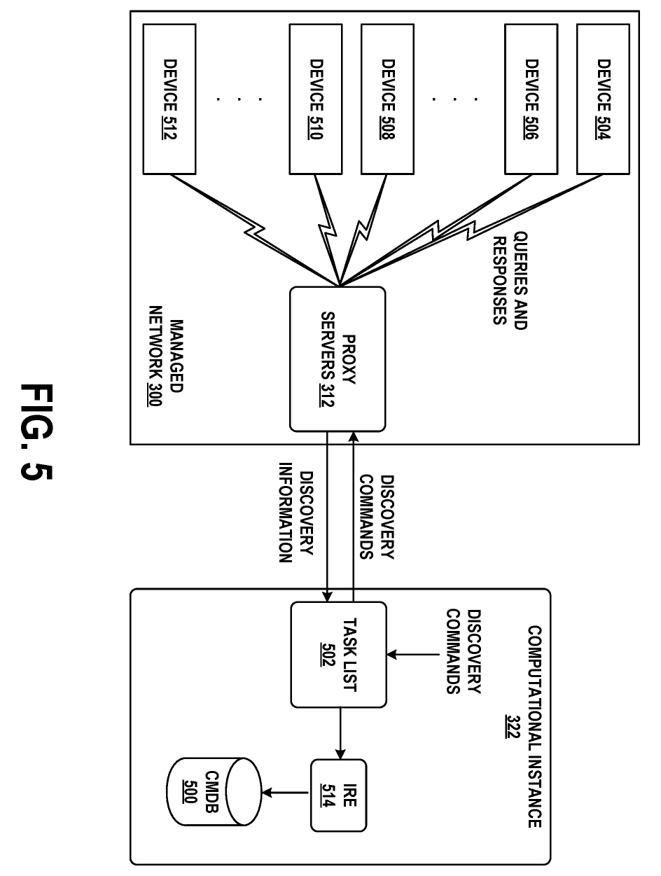

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid / password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery – horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input / output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router’s network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases – under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices – for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item’s attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Generation of Guided Tours

Guided tours for user interfaces are interactive instructional tools designed to help users understand and navigate a software platform (e.g., application or website). These tours typically consist of a series of step-by-step instructions, often presented as pop-up overlays or tooltips, that direct users through features and functionalities of the user interface. Guided tours are used to enhance user onboarding to software platforms by reducing the learning curve, and improving user engagement. For example, guided tours can provide contextual assistance at certain points within an application. Well-designed guided tours help users quickly become proficient with the software platform, leading to increased productivity, reducing the need for extensive documentation or customer support, and also reducing wastage of computing resources (e.g., processing, memory, and/or network capacity) due to user confusion regarding user interface navigation.

Features and content of guided tours include the ability to highlight specific user interface elements, provide detailed explanations of these elements and how they can be used, and include interactive components such as clickable buttons or input fields to allow users to perform tasks. Users may proceed at their own pace, with options to pause, skip, or replay steps. Some guided tours are adaptive, offering personalized experiences based on user behavior or role. Herein, the terms “guided tour” and “guided content” are used synonymously unless context suggests otherwise.

The specification of guided tours involves defining the sequence of steps, the content and format of instructions, the user interface elements to be highlighted, and the interactions required (e.g., the guided tour content being placed in a popup window or overlay atop the user interface). This can be achieved through the use of specialized software libraries or frameworks that integrate with an application, or by using dedicated software tools designed to create and manage these instructional sequences. Additionally, the interactive components of guided tours should not obstruct essential functions of the user interface or overwhelm the user. Instead, they should maintain a balance between thorough instruction and user autonomy.

### A. Example Guided Tour

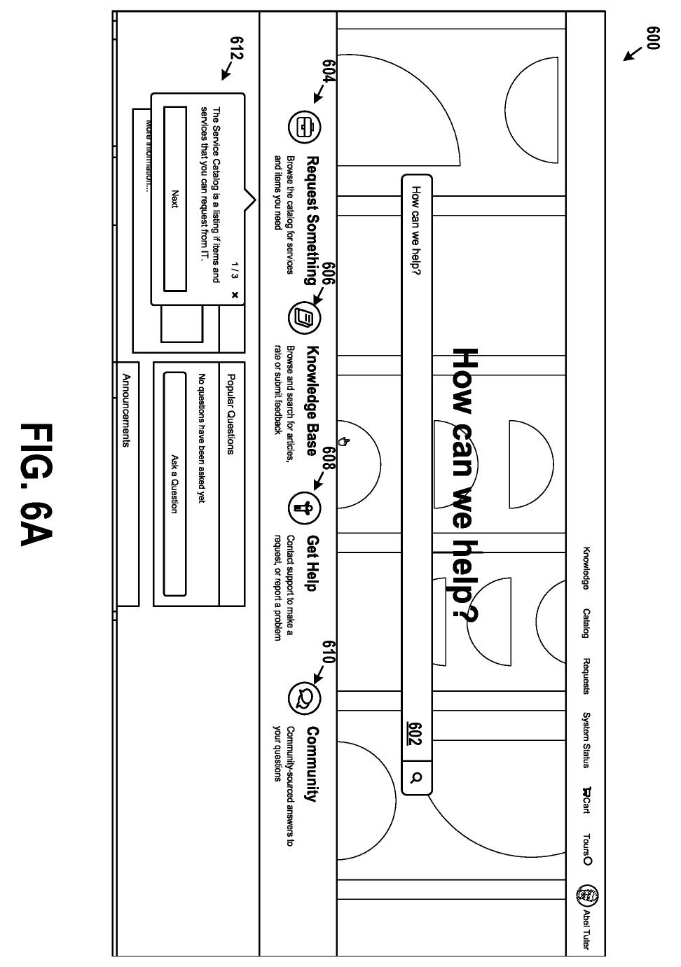

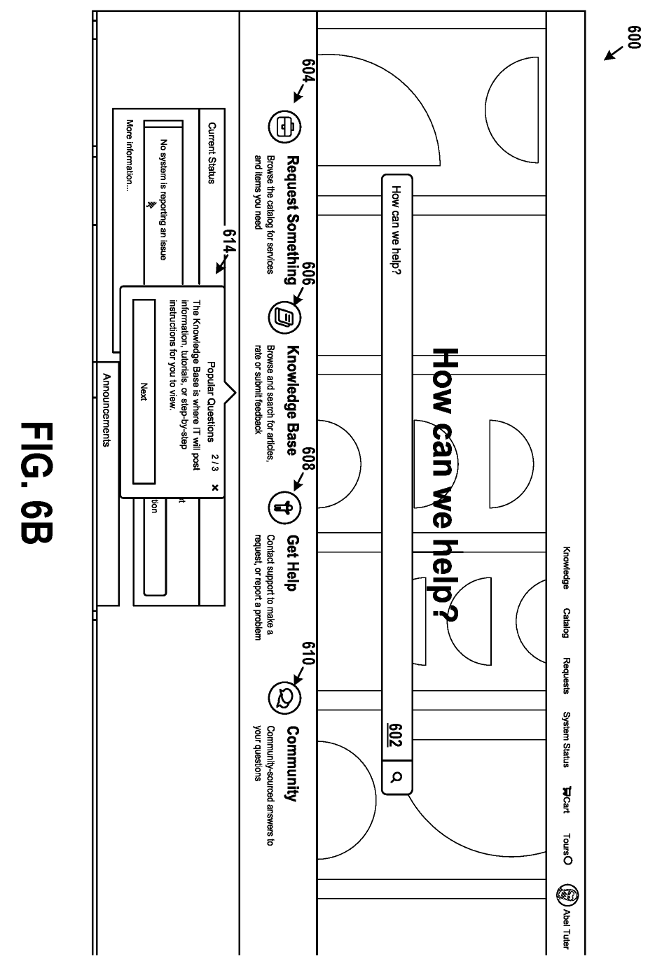

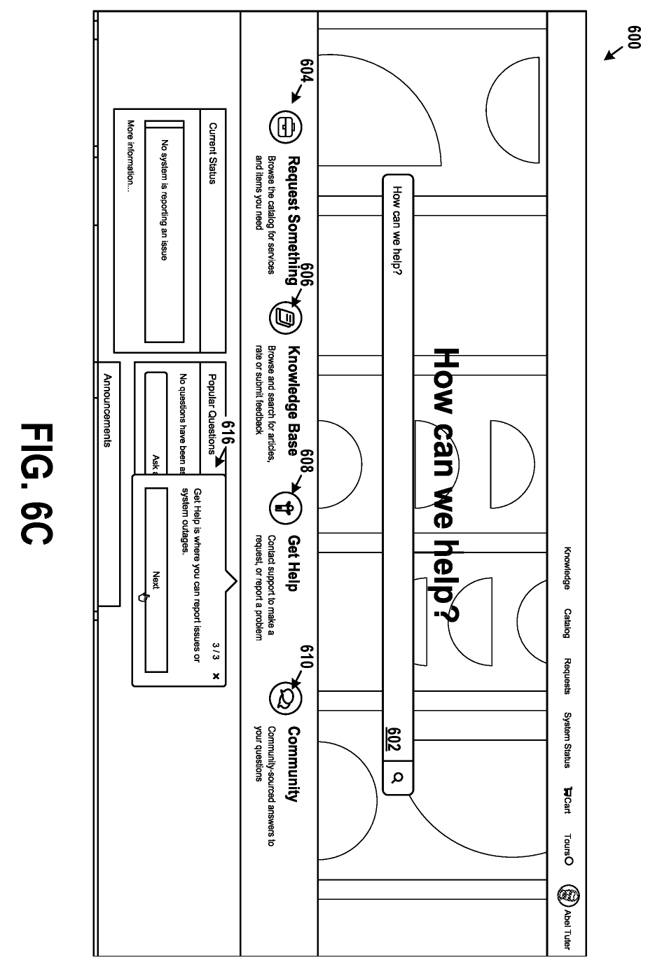

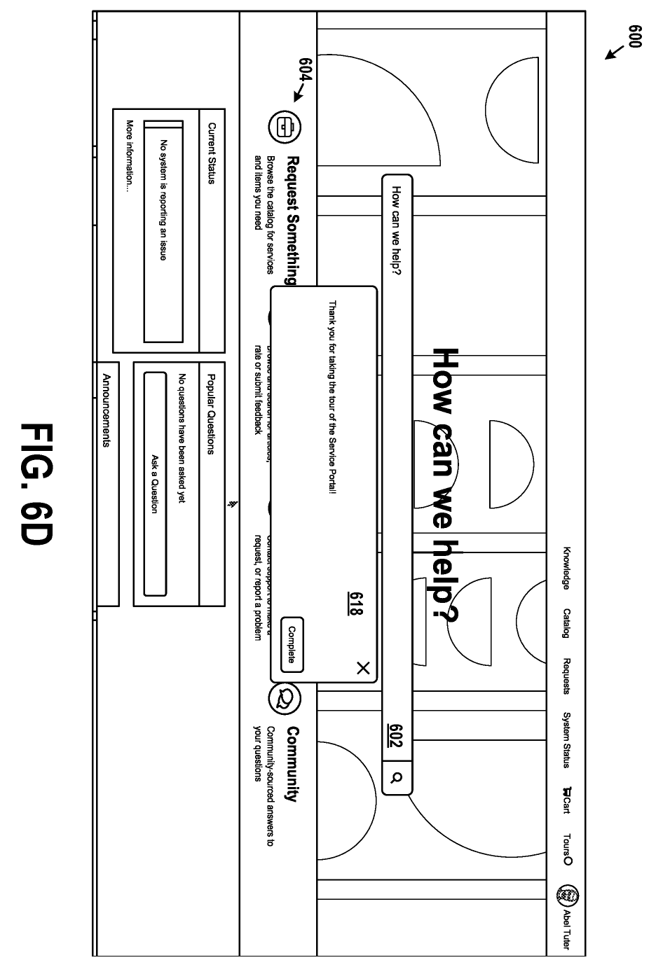

FIGS. 6A, 6B, 6C, and 6D provide an example service portal user interface 600. This user interface includes a search box 602 (e.g., for entering search terms in text format), as well as links to four resources – service catalog 604, knowledge base 606, help 608, and community 610. The depictions in FIGS. 6A, 6B, 6C, and 6D present possible examples of a user interface that could benefit from a guided tour. Other possibilities exist.

Here, service catalog 604 may be a web site through which a user can order physical or non-physical items, such as a new laptop computer or registration to an online training session. Knowledge base 606 may be a centralized repository of information, typically consisting of articles, frequently asked questions (FAQs), tutorials, and documentation, designed to provide users with easy access to knowledge about a particular system, product, or service. Help 608 may be a web site that can be used to contact IT support (e.g., to open and manage help requests), such as when IT services are not operating properly. Community 610 may include one or more message boards through which users and administrators can share information about an organization, project, or other topics.

The first time that a user accesses service portal 600, a guided tour may be shown. This guided tour may include a number of ordered steps that explain the purpose and/or function of each of service catalog 604, knowledge base 606, help 608, and community 610.

For instance, the guided tour may start by displaying popup window 612 as depicted in FIG. 6A. Popup window 612 refers to service catalog 604 and includes a brief textual description of service catalog 604. Popup window 612 also includes a “Next” button that, when actuated, may cause the guided tour to advance.

Particularly, actuation of the “Next” button of popup window 612 may cause the guided tour to display popup window 614 as depicted in FIG. 6B. Popup window 614 refers to knowledge base 606 and includes a brief textual description of knowledge base 606. Popup window 614 also includes a “Next” button that, when actuated, may cause the guided tour to advance.

Specifically, actuation of the “Next” button of popup window 614 may cause the guided tour to display popup window 616 as depicted in FIG. 6C. Popup window 616 refers to help 608 and includes a brief textual description of help 608. Popup window 616 also includes a “Next” button that, when actuated, may cause the guided tour to advance.

Actuation of the “Next” button of popup window 616 may cause the guided tour to display popup window 618 as depicted in FIG. 6D. Notably, popup window 618 signifies the end of the guided tour. After the user actuates the “Complete” button of popup window 618, the guided tour may end and the user may be able to interact normally with service portal 600 and use any of service catalog 604, knowledge base 606, help 608, and community 610.

The guided tour in this case does not include a discussion of community 610. This omission indicates that not all user interface features need to be explicitly discussed or otherwise covered in a guided tour. For example, some features may be well-understood by users or may contain sufficient documentation in other locations that it is not necessary to describe them in a guided tour.

In some variations, the popup windows 612, 614, 616, and/or 618 may include other buttons, such as “Back” button. A “Back” button, when actuated may cause navigation in the reverse direction through the guided tour. For example, actuation of a “Back” button included in popup window 616 may cause popup window 614 to be displayed. Other buttons could be included within such popup windows or elsewhere that facilitate linear or non-linear navigation through a guided tour. For instance, each of popup windows 612, 614, 616, and 618 includes an “X” button that, when actuated, closes the respective popup window and causes the guided tour to end.

As noted previously, a drawback to conventionally-produced guided tours is that they need to be designed and programmed for the software platform on which they are to be deployed. This additional effort requires specialized knowledge of the software platform, its programming interfaces, and time to test and debug the guided tour. Given the vast number of different applications and user interfaces on a remote network management platform (which can easily be in the hundreds or thousands), guided tours are developed for relatively few applications. Further, if a guided tour does not provide a user with a sufficient understanding of how to use the application, the guided tour may not result in the expected savings of computing resources (e.g., processing, memory, and/or network capacity), as the user fails to navigate through pages of the application in an efficient fashion.

The embodiments herein overcome these limitations by using various types of source material that are typically available during feature design processes to automatically generate programmatic content for guided tours.

### B. Example Source Material

In the course of software engineering, several documents may exist that can be used, with the assistance of a natural language processing (NLP) model, to automatically generate source code and/or metadata that defines a guided tour. These may include one or more of a functional requirements document, a user stories document, and/or source code. But other forms of source material may be used.

A functional requirements document (FRD) is a comprehensive specification that outlines the functional aspects of software that is to be developed. It details the software’s intended capabilities, features, and interactions from a user’s perspective, describing what the software should do rather than how it is to be implemented. The content typically includes an overview of the software’s purpose, detailed descriptions of each functional requirement, user interactions, data handling, and any constraints or dependencies. An FRD serves as a reference point throughout the software development lifecycle, allowing stakeholders including developers, testers, and users, to have a clear understanding of the expected functionality of the software. Further, an FRD can be used validate that the software as implemented meets the specified requirements.

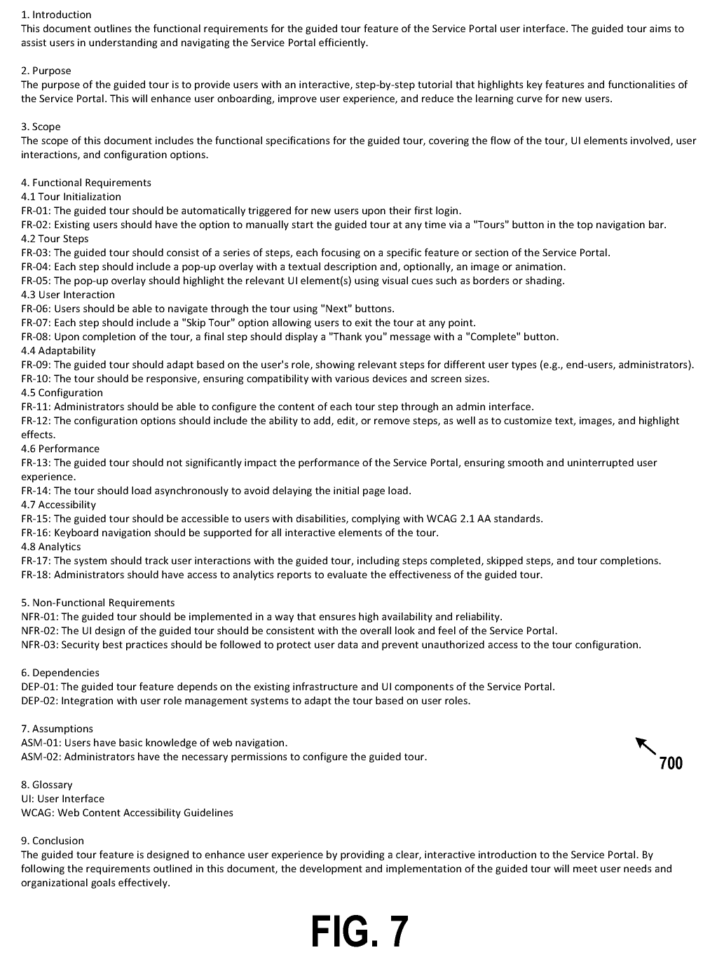

An example FRD 700 for the guided tour of FIGS. 6A-6D is shown in FIG. 7. FRD 700 consists of a set of numbered sections (e.g., Introduction, Purpose, Scope, etc.) and numbered requirements within each section if appropriate (e.g., FR-01 through FR-18 in section 4). These numbered requirements, in particular, set forth features and/or functionality for the software. Thus, each requirement can be used by software engineers during development, testers during quality assurance, and users during acceptance testing. Notably, the requirements are often high-level, and thus may be implemented in various ways. In other words, use of the same FRD could result in different software implementations on different software platforms, or even on the same software platform.

User stories documents typically contain short descriptions of software features told from the perspective of users of those features. They are a component of Agile and Scrum development methodologies and serve as a way to capture user requirements in non-technical language. User stories commonly follow a format such as: “As a [type of user], I want [some goal] so that [some reason].” This may be referred to as the “user / goal / reason” form. A purpose of user stories is to focus the software development process on user needs, as well as to facilitate better communication among designers, software engineers, testers, and users so that the goals of the software are understood without requiring deep technical knowledge.

Each user story may include three main components: the role (identifying the user or persona), the goal (describing what the user wants to do), and the reason (explaining why the user needs this functionality). The benefits of user stories include flexibility, as they allow for adjustments based on evolving user needs and platform requirements, and support for incremental development, so that each piece of the product delivers value and remains focused on user needs. Each story also may include acceptance criteria, which are specific conditions that define when the software is complete and meets the user’s needs.

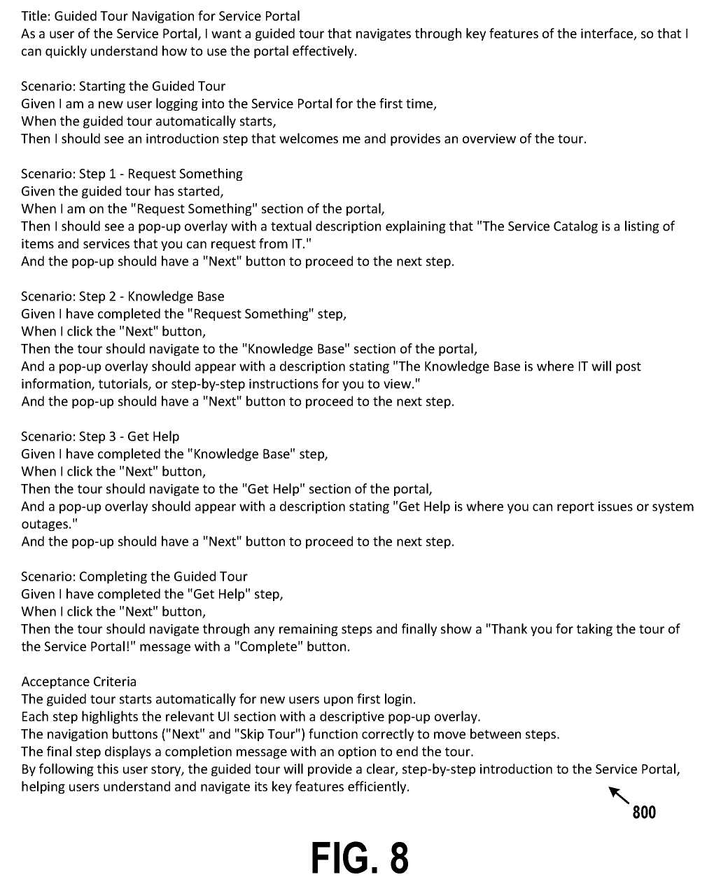

An example user story 800 for the guided tour of FIGS. 6A-6D is shown in FIG. 8. User story 800 consists of requirements in the user / goal / reason form described above, as well as goals for each significant scenario of the software. These goals may be specific – for example, the goals for the knowledge base popup include a description of where the user is in the guided tour, what functionality has led the user to this step, and specific text and button content for the popup.

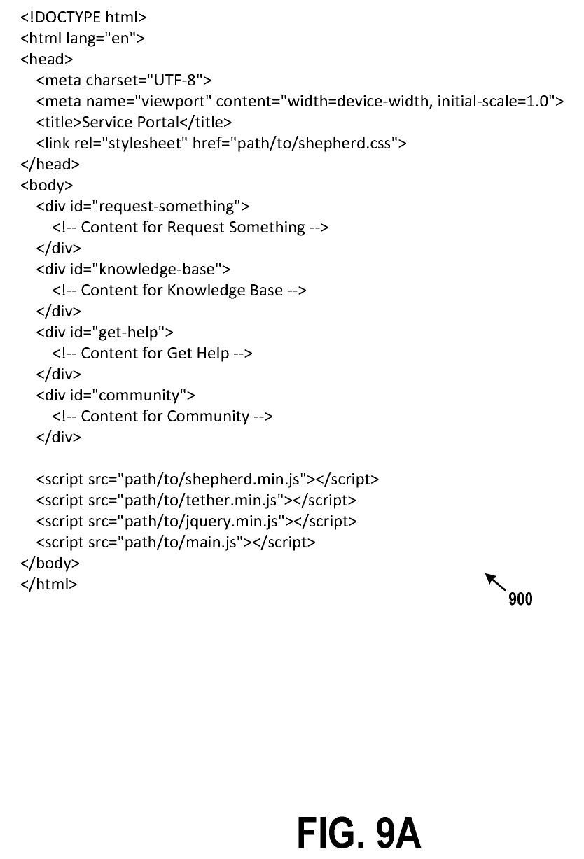

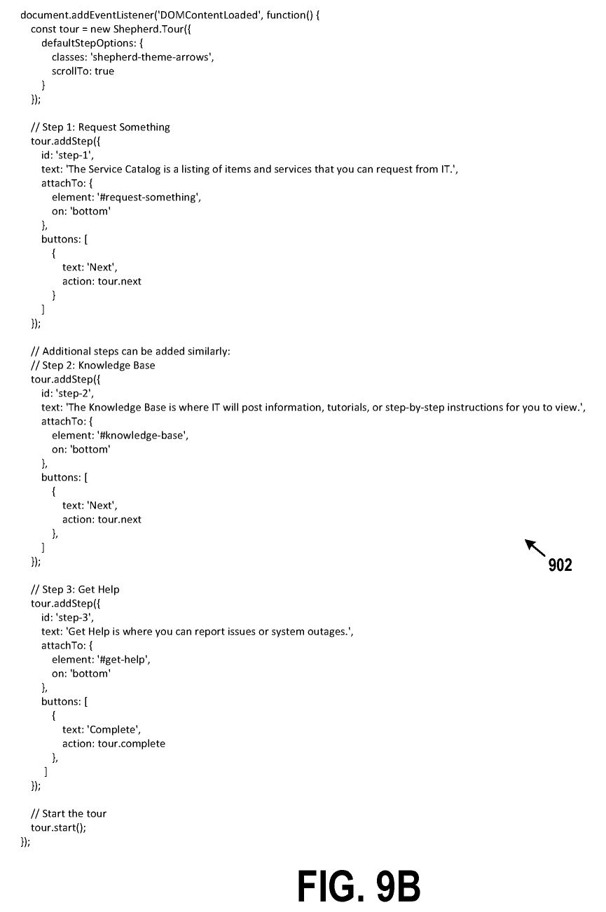

Source code may be pseudocode, a framework for code, partial code, and/or complete code the implement a user interface. Examples of source code are shown in FIGS. 9A and 9B.

FIG. 9A depicts source code in the form of HTML 900, which defines the general structure of the user interface. Notably, the body of HTML 900 (as defined by the text appearing between the <body> and </body> delimiters) includes sections defining each of the features of user interface 600 (e.g., catalog 604, knowledge base 606, help 608, and community 610) and references a number of JAVASCRIPT® libraries for making user interface 600 dynamic and interactive. Here, the detailed HTML for the features of user interface 600 is omitted for purposes of simplicity.

FIG. 9B depicts source code in the form of script 902. Script 902 is coded in JAVASCRIPT® and relies on at least some of the aforementioned libraries. Particularly, script 902 includes methods that define popup windows 612, 614, and 616 in terms of the text and buttons defined for each (discussion of community 610 is omitted for purposes of simplicity).

### C. Example User Interface Definitions

Source code may be used to specify user interfaces in at least two different ways in the embodiments herein. First, NLP may be employed to generate source code to implement the user interface based on an FRD and/or user stories. Second, NLP may be employed to generate user interface metadata for a user interface based on an FRD, user stories, and/or source code. Both possibilities are described herein. Here, NLP may encompass use of a large language model (LLM) as described below.

User interface metadata refers to data that programmatically describes the structure, behavior, and presentation of elements within a software application’s user interface. User interface metadata typically includes information about user interface components such as forms, buttons, menus, and interactive elements, specifying attributes like their size, position, visibility, and interaction rules. Additionally, user interface metadata defines the relationships between different user interface elements and their corresponding backend data (e.g., that is stored in a database), enabling dynamic content rendering and user-specific customizations. It may also include localization data to support multiple languages and regions, accessibility information to provide compliance with standards, and theming details for consistent styling across the software application. By using user interface metadata, software engineers can create flexible and adaptable user interfaces that can be modified and extended without altering the underlying codebase. Particularly, the metadata definitions of a user interface can be used by an interpreter to generate user interfaces dynamically at runtime. Advantageously, the user interfaces can be modified by editing the metadata directly rather than undertaking the more error-prone approach of recoding user interface software.

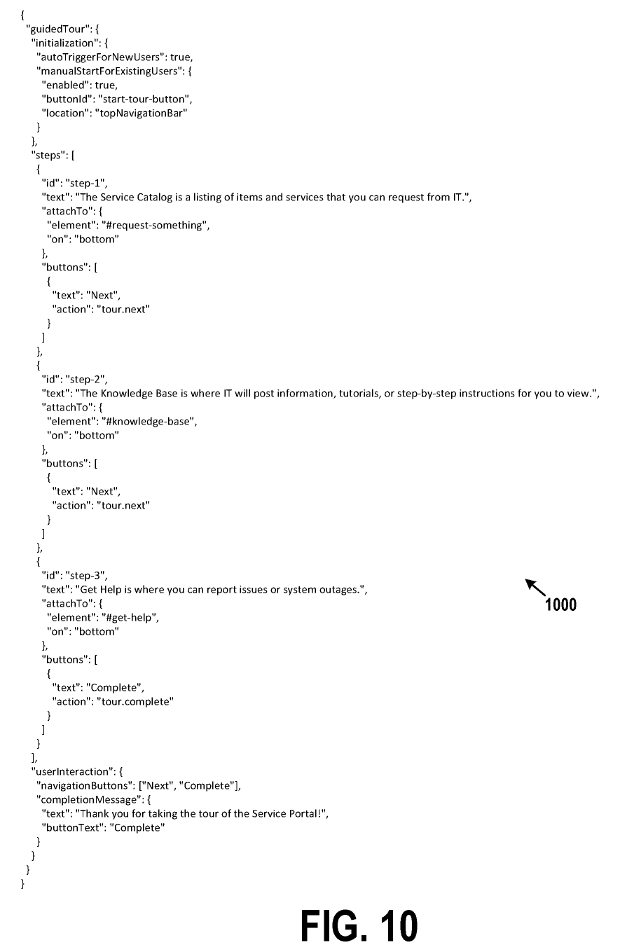

An example of user interface metadata that defines a guided tour user interface confirming to that of FIGS. 6A-6D is shown in FIG. 10. Notably, user interface metadata 1000 includes definitions of the guided tour in general as well as elements (in the “steps” structure) for each of the popup windows 612, 614, 616, and 618.

The user interface metadata of FIG. 10, as well as other user interface definitions of FIGS. 7, 8, 9A and 9B, are illustrative and simplified for purposes of presentation. Thus, they may not contain all information necessary for generation of a user interface similar to that of user interface 600. However, a person of ordinary skill in the art would be able to infer how source code and/or metadata could be generated using natural language processing with these examples, in accordance with the discussion herein.

### D. Natural Language Processing Models

NPL models may be used to facilitate generation of user interface source code directly, or user interface metadata that can be interpreted at runtime to produce an interactive user interface. These NPL models may include general and/or customized large language models (LLMs).

An LLM is an advanced computational model, primarily functioning within the domain of NLP and machine learning. An LLM can be configured to understand, interpret, generate, and respond to human language in a manner that is both contextually relevant and syntactically coherent. The underlying structure of an LLM is typically based on a neural network architecture, more specifically, a variant of the transformer model. Transformers are notable for their ability to process sequential data, such as text, with high efficiency.

The operation of an LLM involves layers of interconnected processing units, known as neurons, which collectively form a deep neural network. This network can be trained on vast datasets comprising text from diverse sources, thereby enabling the LLM to learn a wide array of language patterns, structures, and colloquial nuances for prose, poetry, and program code. The training process involves adjusting the weights of the connections between neurons using algorithms such as backpropagation, in conjunction with optimization techniques like stochastic gradient descent, to minimize the difference between the LLM’s output and expected output.

An aspect of an LLM’s functionality is its use of attention mechanisms, particularly self-attention, within the transformer architecture. These mechanisms allow the model to weigh the importance of different parts of the input text differently, enabling it to focus on relevant aspects of the data when generating responses or analyzing language. The self-attention mechanism facilitates the model’s ability to generate contextually relevant and coherent text by understanding the relationships and dependencies between words or tokens in a sentence (or longer parts of texts), regardless of their position.

Upon receiving an input, such as a text query or a prompt, the LLM may process this input through its multiple layers, generating a probabilistic model of the language therein. It predicts the likelihood of each word or token that might follow the given input, based on the patterns it has learned during its training. The model then generates an output, which could be a continuation of the input text, an answer to a query, or other relevant textual content, by selecting words or tokens that have the highest probability of being contextually appropriate.

Furthermore, an LLM can be fine-tuned after its initial training for specific applications or tasks. This fine-tuning process involves additional training (e.g., with reinforcement from humans), usually on a smaller, task-specific dataset, which allows the model to adapt its responses to suit particular use cases more accurately. This adaptability makes LLMs highly versatile and applicable in various domains, including but not limited to, chatbot development, content creation, language translation, and sentiment analysis.

As an example, the LLMs described herein may be fine-tuned on user interface metadata deployed in remote network management platform 320 so that they can learn the relationships between this metadata, its functionality on the software platform, and human language descriptions thereof. In this manner, such a customized LLM can be used to generate, from at least FRDs and/or user stories, user interface metadata that is readily deployed on remote network management platform 320.

Some LLMs are multimodal in that they can receive prompts in formats other than text and can produce outputs in formats other than text. Thus, while LLMs are predominantly designed for understanding and generating textual data, multimodal LLMs extend this functionality to include multiple data modalities, such as visual and auditory inputs, in addition to text.

A multimodal LLM can employ an advanced neural network architecture, often a variant of the transformer model that is specifically adapted to process and fuse data from different sources. This architecture integrates specialized mechanisms, such as convolutional neural networks for visual data and recurrent neural networks for audio processing, allowing the model to effectively process each modality before synthesizing a unified output.

The training of a multimodal LLM involves multimodal datasets, enabling the model to learn not only language patterns but also the correlations and interactions between different types of data. This cross-modal training results in multimodal LLMs being adept at tasks that require an understanding of complex relationships across multiple data forms, a capability that text-only LLMs do not possess. This makes multimodal LLMs particularly suited for advanced applications that necessitate a holistic understanding of multimodal information, such as chatbots that can interpret and produce images and/or audio.

Notably, multimodal LLMs can be used with the embodiments herein when an FRD or user stories document contains images. The multimodal LLM may be able to interpret the content of the images in the grater context of the document to produce a more accurate rendering of user interface source code or metadata.

### E. User Interface Generation

As discussed above, a user interface can be generated based on some combination of an FRD, user stories document, and/or source code. The generated user interface may include source code (e.g., based on the FRD and/or user stories document) or metadata (e.g., based on FRD, user stories document, and/or source code).

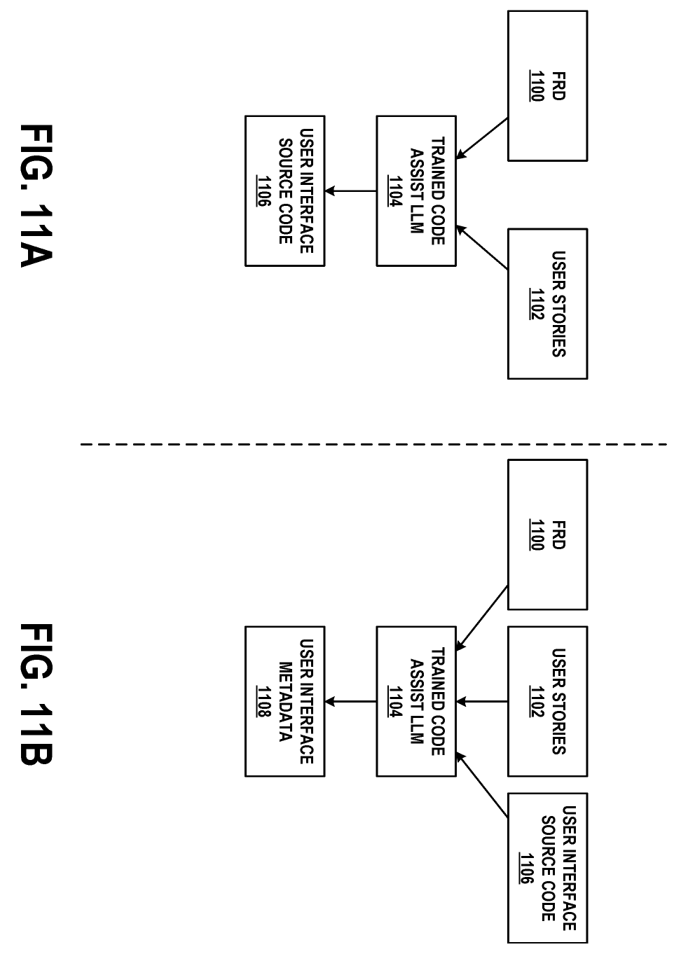

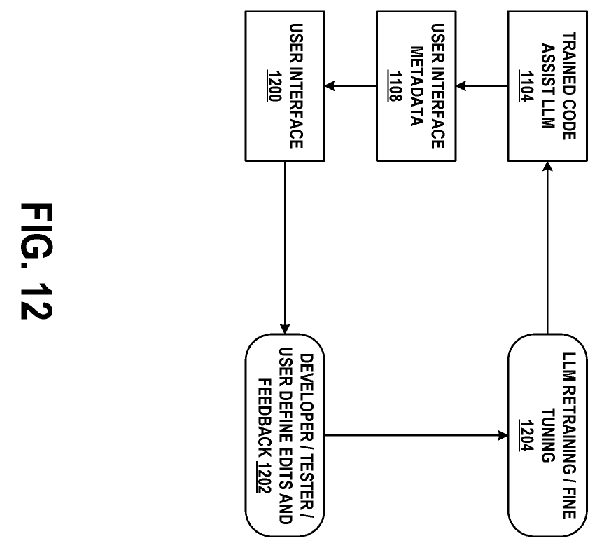

FIGS. 11A and 11B illustrated these procedures. In FIG. 11A, trained code assist LLM 1104 is configured to receive FRD 1100 (of which FRD 700 is an example) and user stories 1102 (of which user story 800 is an example), and responsively generate user interface source code 1106 (of which HTML 900 and script 902 are examples). For instance, a user interface designer might provide FRD 1100 and user stories 1102 to trained code assist LLM 1104, and receive as output user interface source code 1106 (e.g., HTML and/or scripts).

Alternatively or additionally, in FIG. 11B trained code assist LLM 1104 is configured to receive FRD 1100, user stories 1102 and user interface source code 1106, and then responsively generate user interface metadata 1108 (of which metadata 1000 is an example). For instance, a user interface designer might provide FRD 1100, user stories 1102, and user interface source code 1106 to trained code assist LLM 1104, and receive as output user interface metadata 1108.

In some cases, the procedures of FIGS. 11A and 11B may be used in tandem. For example, a user interface designer may first generate user interface source code 1106 using the procedures of FIG. 11A, then provide user interface source code 1106 as input to generate user interface metadata 1108 using the procedures of FIG. 11B. Other variations may be possible.

Trained code assist LLM 1104 may be either a general LLM (private, customized, or third party) with code and metadata generation capabilities, or a specialized LLM trained specifically for code and/or metadata generation. For example, trained code assist LLM 1104 may be trained on mappings between (i) FRDs and/or user stories documents, and (ii) user interface source code from remote network management platform 320. Alternatively or additionally, trained code assist LLM 1104 may be trained on mappings between (i) FRDs, user stories documents, and/or user interface source code, and (ii) user interface metadata from remote network management platform 320.

Remote network management platform 320 may contain hundreds or thousands of examples of these mappings for the various applications that it supports. Further, remote network management platform 320 may contain specifications of user interface metadata and other metadata (e.g., database interface metadata) that it supports. Thus, trained code assist LLM 1104 may be able to infer relationships between these items with enough particularity to generate usable production-quality source code and/or metadata, or at least source code and/or metadata that is readily adaptable for production-quality use. As an example, the transformer structures within trained code assist LLM 1104 may be able to codify representations of relationships between these items. Alternatively, trained code assist LLM 1104 may be trained and/or fine-tuned on curated and/or supervised data from remote network management platform 320.

In some cases, trained code assist LLM 1104 may be controlled (at least in part) by way of textual prompts. For instance, an FRD and user stories document may be provided to trained code assist LLM 1104 in the form of a prompt that also includes a command or request. An example of such a prompt may be “Based on this functional requirements document ‘[FRD]’ and user stories document ‘[user stories]’, generate metadata for a guided tour of a user interface that complies with the requirements and specifications provided.” Here, the token [FRD] would be replaced by the functional requirements document, and the token [user stories] would be replaced by the user stories document.

Further processing not explicitly shown in FIGS. 11A and 11B may include creating, based on the output of trained code assist LLM 1104, actions or steps within an administrative interface for guided tour creation, and then auto-populating the guided tour based on these actions or steps. In some embodiments, explanatory text within the popup windows may be converted to audio using text-to-speech processing. This allows the guided tour to be used by visually-impaired users, for example.

### F. Model Feedback and Retraining

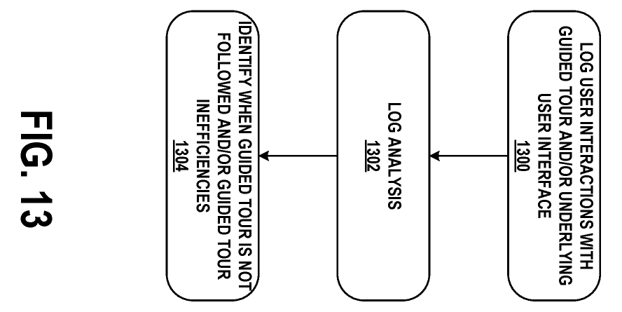

Feedback regarding use of generated user interfaces may be provided by developers, testers, and users of the user interfaces. In some cases, this feedback can be employed to retrain and/or fine tune trained code assist LLM 1104. A process for doing so is shown in FIG. 12. Notably, blocks in FIG. 12 with square corners generally represent objects (e.g., software and data), whereas blocks in FIG. 12 with rounded corners generally represent one or more steps of a procedure. Nonetheless, these designations are merely for convenience and other implementations are possible.

User interface metadata 1108 may be used to populate a guided tour feature of user interface 1200. This initial version of the guided tour may be sufficient for production use and may meet most user expectations. However, before or after production deployment of user interface 1200, developers, testers, and/or users may define and provide corrections, edits, or other feedback 1202 for user interface 1200. As an example, a developer might correct a grammatical issue in the guided tour text of a popup window, a tester might suggest moving the location of the “Next” button for a popup window, and/or a user might suggest a different ordering of steps in the guided tour.

This feedback may be gathered, and at least some of it used for LLM retraining / fine tuning 1204. In these cases, the feedback could be employed for supervised training of trained code assist LLM 1104, thereby improving the model’s capability to produce correct, visually appealing, and useful guided tours. In some cases, this feedback may, in whole or in part, be used to automatically retrain or fine-tune a new version of trained code assist LLM 1104.

A further level of feedback may also be incorporated, for example after a user interface with a guided tour is deployed in production. Remote network management platform 320 may be configured to log some or all user interface state changes that users cause during their interaction with the user interface. Then, these logs can be analyzed to identify situations where: (i) a user did not complete the guided tour, and/or (ii) the behavior of users who completed at least part of the guided tour differs from users who did not use the guided tour at all.

For example, each web request or database access caused by a user interacting with the user interface may be individually logged to a user activity log file or database table. Thus, if a user’s journey through an application involves loading web page A, then web page B, then web page C, each of these activities may be logged (e.g., with a text entry representing the user’s identification, the URLs of these web pages, and the times of each access). Likewise, if a user traverses a multi-step guided tour, the user’s interactions with the guided tour may also be logged (e.g., with a text entry representing the user’s identification, identifiers of the guided tour and the steps, and the times of each access). In this manner, each user’s path through the guided tour and its associated web sites may be captured.

FIG. 13 depicts such a process. At step 1300, user interactions with a guided tour and/or the underlying user interface are logged. For example, each user request (e.g., web request), user interface actuation, and/or resulting client/server transaction may be recorded.

At step 1302, log analysis is performed on the resulting logs. For example, the log analysis may identify for each user, (i) whether the guided tour feature was activated, (ii) whether the user completed the guided tour if it was activated, and (iii) traces of user navigation for each user who interacted with the user interface regardless of whether the guided tour was activated. These traces may take the form of directed cyclic or directed acyclic graphs in which each node represents a user interface interaction for a specific user and each edge identifies a directionality (e.g., with an arrow) of the user’s journey between two nodes (synthetic start and end nodes may be added for completeness). In some cases, a specially-trained LLM (e.g., other than trained code assist LLM 1104) or other form of machine-learning model may be employed to perform log analysis and convert the results into training data and/or updates for trained code assist LLM 1104.

At step 1304, results of this log analysis may be stored and/or presented. For example, each trace may indicate whether the guided tour was activated when the user’s interactions created the constituent logs.

Further, each trace may indicate whether the guided tour was completed or the user exited the guided tour prior to completion. If more than a threshold percentage of the users (e.g., the majority of users) complete the guided tour, it may be reasonable to conclude that the guided tour is providing a useful function for users in general. However, if less than the threshold percentage of users complete the guided tour, it may be reasonable to conclude that the guided tour is not needed (e.g., most users can navigate the user interface efficiently without it) or the guided tour is not providing sufficiently clear assistance to users and they are skipping steps of it as a result.

Moreover, given that the guided tour can be activated or deactivated on a per-user basis, it is possible to conduct live A/B experimental trials on a production deployment of a guided tour. As an example, a random 50% of the users might be shown the guided tour and the remaining users might not be shown the guided tour. Then, graph comparison algorithms can be used to identify whether the users who had access to the guided tour behaved differently than the users who did not have access to the guided tour in terms of their interactions with the user interface.

For example, the graph analysis algorithms might identify whether a user who does or does not have access to or use the guided tour is more likely to do any one of more of the following: (i) complete a defined task in fewer steps (indicating a more efficient use of the user interface), (ii) ping-pong or cycle between the same web pages or guided tour steps (indicating user confusion and possible poor design), or (iii) give up and stop interacting with the user interface (indicating user frustration and possible poor design). Here, the defined task may be represented by a canonical workflow (e.g., opening an incident report, submitting a form, approving a request).

Based on these results, feedback can be provided to designers and/or trained code assist LLM 1104. For instance, the embodiments of FIG. 13 might identify not just the results, but also suggest improvements to the guided tour. These improvements could be adding or removing steps from the guided tour, clarifying the text displayed for each step, and so on.

The feedback, potentially including any identified improvements, can be used for retraining and/or fine tuning of trained code assist LLM 1104 so that guided tours produced in the future are likely to reflect the feedback. The feedback may also be generated for and/or provided to user interface designers to enhance the user interface design. For example, if the analysis of user behavior indicates that users rarely follow a particular path through the user interface and instead follow a different path, this can be taken into account for a future iteration of the user interface. Consequently, the user interface’s FRD and user stories documentation may be updated accordingly.

### VIII. Example Operations

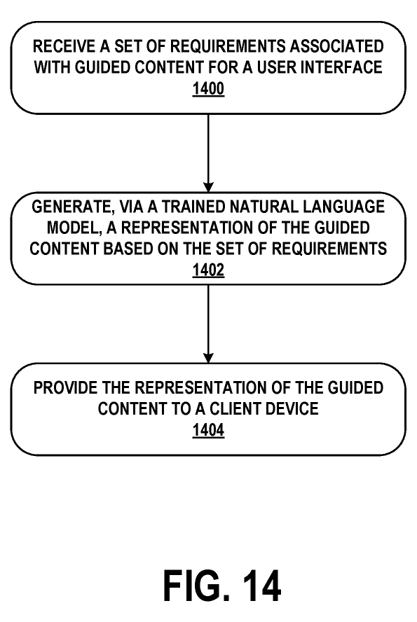

FIG. 14 is a flow chart illustrating an example embodiment. The process illustrated by FIG. 14 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 14 may be simplified by the removal of any one or more of the features shown therein. Further, these embodiments may be combined with features, aspects, and/or implementations of any of the previous figures or otherwise described herein.

Block 1400 may involve receiving a set of requirements associated with guided content for a user interface.

Block 1402 may involve generating, via a trained natural language model, a representation of the guided content based on the set of requirements. This facilitates more efficient navigation of the user interface, which results in less wastage of computing resources because users are less likely to wander about the user interfaces while seeking particular information or capabilities.

Block 1404 may involve providing the representation of the guided content to a client device.

In some implementations, the representation includes user interface content associated with the user interface, wherein the representation also includes tutorial content associated the guided content.

Some implementations may involve receiving the set of requirements from the client device, wherein providing the representation of the guided content is in response to receiving a request for the guided content from the client device.

In some implementations, the guided content includes a series of steps describing aspects of the user interface.

In some implementations, the set of requirements includes a textual description of the guided content, and generating the representation of the guided content includes the trained natural language model performing natural language processing on the textual description to produce the representation of the guided content.

In some implementations, the textual description of the guided content includes source code related to the user interface.

In some implementations, the textual description of the guided content includes metadata that programmatically defines the guided content.

In some implementations, the textual description of the guided content includes a functional requirements document and a user stories document.

In some implementations, the trained natural language model was trained on a plurality of mappings between: (i) sets of requirements associated with respective guided content for respective user interfaces, and (ii) respective representations of the respective guided content based on the set of requirements.

Some implementations may involve: receiving feedback relating to the representation of the guided content; and, in response to receiving the feedback, retraining the trained natural language model based on the feedback.

Some implementations may involve: recording traversals of the user interface by a plurality of client devices; and determining efficacy of the guided content based on the traversals.

In some implementations, the traversals of the user interface by a plurality of client devices include a first set of traversals in which the guided content was provided and a second set of traversals in which the guided content was not provided.

In some implementations, determining efficacy of the guided content based on the traversals comprises determining that some of the traversals exhibit one or more of: completing a defined task involving the user interface in more than a threshold number of steps, cycling between pages or components of the user interface or guided content, or ending without completing the defined task involving the user interface.

### IX. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving a set of requirements associated with guided content for a user interface;
generating, via a trained natural language model, a representation of the guided content based on the set of requirements; and
providing the representation of the guided content to a client device.

2. The method of claim 1, wherein the representation includes user interface content associated with the user interface, and wherein the representation includes tutorial content associated the guided content.

3. The method of claim 1, further comprising:
receiving the set of requirements from the client device, wherein providing the representation of the guided content is in response to receiving a request for the guided content from the client device.

4. The method of claim 1, wherein the guided content includes a series of steps describing aspects of the user interface.

5. The method of claim 1, wherein the set of requirements includes a textual description of the guided content, and wherein generating the representation of the guided content includes the trained natural language model performing natural language processing on the textual description to produce the representation of the guided content.

6. The method of claim 5, wherein the textual description of the guided content includes source code related to the user interface.

7. The method of claim 5, wherein the textual description of the guided content includes metadata that programmatically defines the guided content.

8. The method of claim 5, wherein the textual description of the guided content includes a functional requirements document and a user stories document.

9. The method of claim 1, wherein the trained natural language model was trained on a plurality of mappings between: (i) sets of requirements associated with respective guided content for respective user interfaces, and (ii) respective representations of the respective guided content based on the set of requirements.

10. The method of claim 1, further comprising:
receiving feedback relating to the representation of the guided content; and
in response to receiving the feedback, retraining the trained natural language model based on the feedback.

11. The method of claim 1, further comprising:
recording traversals of the user interface by a plurality of client devices; and
determining efficacy of the guided content based on the traversals.

12. The method of claim 11, wherein the traversals of the user interface by the plurality of client devices include a first set of traversals in which the guided content was provided and a second set of traversals in which the guided content was not provided.

13. The method of claim 11, wherein determining efficacy of the guided content based on the traversals comprises determining that some of the traversals exhibit one or more of: completing a defined task involving the user interface in more than a threshold number of steps, cycling between pages or components of the user interface or guided content, or ending without completing the defined task involving the user interface.

14. A non-transitory computer-readable medium, having stored thereon program instructions that, upon execution by a computing system, cause the computing system to perform operations comprising:
receiving a set of requirements associated with guided content for a user interface;
generating, via a trained natural language model, a representation of the guided content based on the set of requirements; and
providing the representation of the guided content to a client device.

15. The non-transitory computer-readable medium of claim 14, wherein the guided content includes a series of steps describing aspects of the user interface.

16. The non-transitory computer-readable medium of claim 14, wherein the set of requirements includes a textual description of the guided content, and wherein generating the representation of the guided content includes the trained natural language model performing natural language processing on the textual description to produce the representation of the guided content.

17. The non-transitory computer-readable medium of claim 14, the operations further comprising:
receiving feedback relating to the representation of the guided content; and
in response to receiving the feedback, retraining the trained natural language model based on the feedback.

18. The non-transitory computer-readable medium of claim 14, the operations further comprising:
recording traversals of the user interface by a plurality of client devices; and
determining efficacy of the guided content based on the traversals.

19. The non-transitory computer-readable medium of claim 18, wherein determining efficacy of the guided content based on the traversals comprises determining that some of the traversals exhibit one or more of: completing a defined task involving the user interface in more than a threshold number of steps, cycling between pages or components of the user interface or guided content, or ending without completing the defined task involving the user interface.

20. A system comprising:
one or more processors; and
memory, containing program instructions that, upon execution by the one or more processors, cause the system to perform operations comprising:
receiving a set of requirements associated with guided content for a user interface;
generating, via a trained natural language model, a representation of the guided content based on the set of requirements; and
providing the representation of the guided content to a client device.
